(19) United States
(12) Patent Application Publication
(10) Pub. No.: US 2014/0104331 A1
(43) Pub. Date: Apr. 17, 2014

(54) METHOD FOR APPLYING A MARKER TO AN ELECTRICAL CABLE DURING MANUFACTURE

(71) Applicant: Smartwater Limited, London (GB)

(72) Inventor: Michael Cleary, London (GB)

(73) Assignee: SMARTWATER LIMITED, London (UK)

(21) Appl. No.: 13/639,099

(22) PCT Filed: Jun. 21, 2012
(86) PCT No.: PCT/GB12/51439

§ 371 Date: Jan. 8, 2013

(30) Foreign Application Priority Data
Jun. 22, 2011 (GB) 1110508.7

(51) Int. Cl. B41J 3/407

(52) U.S. Cl. CPC B41J 3/407
USPC 347/4

(57) ABSTRACT

There is provided a method for manufacturing a uniquely identifiable cable, the method comprising: providing one or more cables including an insulating layer thereon to be wound onto a drum or reel; and applying a marker system onto the surface of the insulating layer of the one or more cables prior to or during the winding of the one or more cables onto the drum or reel.

### FIELD OF THE INVENTION

The present invention relates to a method of manufacturing a cable. In particular, the present invention relates to a marker system for applying to the surface of an insulating layer of cable.

### BACKGROUND TO THE INVENTION

Copper is used extensively in electrical cable due to its high conductivity and corrosion resistance. As it has a particularly high price, it is commonly the subject of theft. This problem is growing increasingly common with not only copper but has extended to all types of non-ferrous metals.

The most common use of such material within the national infrastructure is in the form of electrical cable which is usually copper based due to its high resistance to corrosion and good electrical conductance.

Accordingly, the theft of such metal items is particularly costly for the party suffering the loss, not only due to the high value of the materials involved but the ensuing loss due to disruption of business and infrastructure can be orders of magnitude higher. For example, the theft of electrical cable can not only cause massive disruption due to malfunction of the devices in which it was in use but these thefts can also put people at risk of serious injury.

There is therefore a need to prevent or at least reduce the level of such theft. A way of doing this is to provide a mark on the material which establishes proof of ownership. In this way theft can be established and charges brought against those in possession of items which could positively be identified as stolen.

The use of marker systems is now an established method proven to be effective in the reduction of theft of valuable items. Items of value can be marked easily within the home or office environment. Examples within the realm of general office equipment include P.C.s, laptops, servers, photocopiers, printers all of which can be marked. Likewise examples in the domestic environment include P.C.s, laptops, routers, photocopiers, printers, jewellery, watches, musical instruments, pieces of art and items of sentimental value all of which can be marked simply in a matter of seconds by the addition of a marker.

While it is quite easy to mark a laptop within the domestic or commercial environment, the marking of an electrical cable which can be several miles long when wound onto a drum and which can weigh several tons is another matter. Clearly a different approach is required to effectively mark such a large item in a way which is effective, consistent and reproducible.

There is therefore a need for a marker system for application to the surface of an insulating layer of a cable and an effective, consistent and reproducible method of manufacturing a cable comprising a marker system capable of identifying the source of the cable.

### SUMMARY OF THE INVENTION

In a first aspect of the invention, there is provided a method for manufacturing a uniquely identifiable cable, the method comprising: providing one or more cables including an insulating layer thereon to be wound onto a drum or reel; and applying a marker system onto the surface of the insulating layer of the one or more cables prior to or during the winding of the one or more cables onto the drum or reel.

Preferably, the marker system may be applied during the manufacture of the electrical cable and after the insulation layer has been applied. The apparatus required may be adapted such that it can deal with items weighing several tons and/or can deal with one or more cables of considerable length.

After the insulation layer has been applied to the metal conductor, the cable is passed through an apparatus for applying the marker. The exact apparatus may be adapted to depend upon local factors and the size or flexibility of the cable in use. In general due to a potential lack of flexibility in the heavier gauge cable the method suited to all types of cable involved requires the minimum change of shape in the cable as it goes through the marking process.

In one embodiment of the present invention the composition of the marker system may be typical of an ink or pigment dispersion and in that way its ability to mark a surface permanently is increased. This modification is achieved by the addition of various additives such as viscosity modifiers, thixotropic agents, surfactants or anti-foaming agents. The exact formulation may be varied depending upon the surface being coated and the method of application. Preferably, the marker system may be an ink.

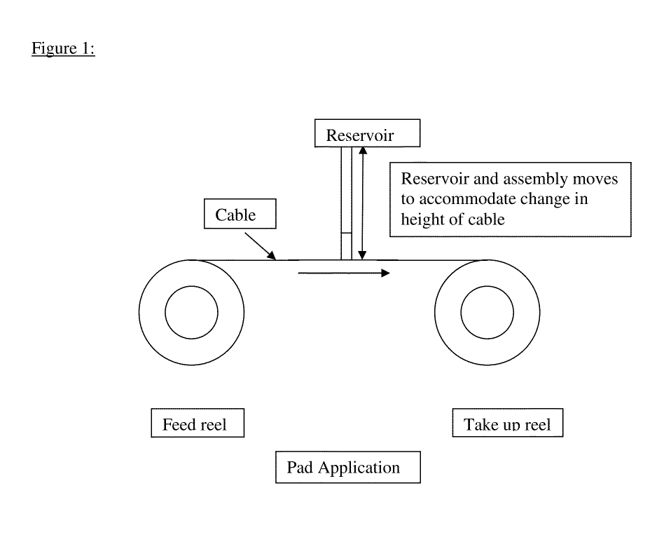

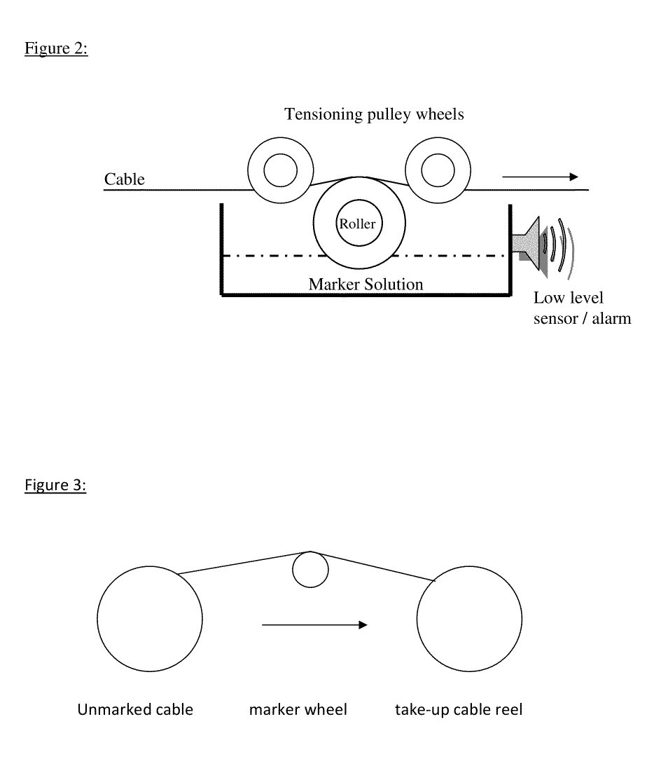

In one embodiment of the invention, it is provided that the marker system may be applied to the insulation layer of the cable by several methods including spraying the cable, passing the cable between rollers or brushes, passing it over/under pads as shown in FIG. 1, wetted with the marker solution, causing it to run along a groove in the top of a wheel, the bottom of which passes through the marker solution, as shown in FIGS. 2, 3 and 4 or passing it through a bath containing the marker solution, or a combination of the application methods detailed herein.

Various methods of application can be used including passing the cable through a bath of marker, passing over brushes, pads and/or rollers and also spraying. When applying by brush, provisions may be made to ensure that the brush is kept wet without swamping the cable. Preferably, the applicator pad may be kept moist from a reservoir. Preferably, the reservoir is located above the applicator pad with the liquid flow from the reservoir to the pad controlled to avoid too much liquid flooding the pad.

In one embodiment of the invention, the application occurs as detailed in FIG. 1. As detailed in this embodiment, the tubing connecting the reservoir with the pad applicator is telescopic to allow for differences in the cable height relative to the applicator as the cable fills the receptor reel. Additionally or optionally, similar equipment as detailed in respect of FIG. 1 may be used in respect of the application of the fingerprint as part of an ink used to print information onto the cable as it passes underneath the print head. Preferably, screen printing could be used, but the marker system may be applied as part of any type of ink.

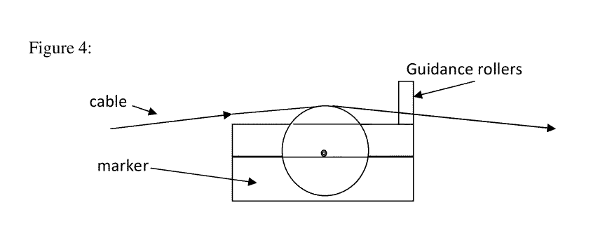

In a further embodiment as shown in FIG. 2 and FIG. 3, the marker applicator is slightly above both the reel holding the cable and the take up reel. FIG. 4 shows an expanded view of the centre section of FIG. 3. In this embodiment the cable passes along a slot at the top of a wheel with the bottom of the wheel passing through the marker solution.

The marker wheel may consist of a grooved wheel which is rotated by the pull of the cable as it passes from the reel of un-marked cable to the take up reel. Further details on this are shown in FIG. 2.

A further embodiment involves the use of three rollers, two tensioning and one that transfers marker from a bath to the cable. Preferably, an alarm may be provided to sense if the marker liquid in the bath reaches a low level. The middle roller can be lowered periodically so that only sections of the cable are marked when required.

In one embodiment of the invention, the insulating layer may comprise a plastic type material. The insulating layers may comprise polypropylene and/or polyvinyl chloride, or a combination thereof.

Difficulties can develop in controlling the marker system which has been applied to the insulating layer of the cable, particularly during the winding of the cable onto the drum or reel. This is because the marker system may be thrown from the reel during the winding by centrifugal force. Further, the marker system may also drip from the reel or drum on standing once the cable has been wound. It is commonly the case that more than one reel is being wound at any one time and if they are in close proximity there is also the danger of marker from one reel being thrown onto an adjacent reel which could undermine the whole marking process.

In another embodiment of the invention, the method further comprises the step of drying the cable once the marker system has been applied to the insulating layer. Preferably, the cable may be dried using rapid drying means. Preferably, the marker system is dried onto the insulating layer of the cable prior to the cable being wound onto the reel to overcome problems associated with the liquid marker on the reel or drum.

However in some situations the reel may be wound so quickly that it may not be possible to dry the marker system fully onto the surface of the insulating layer before the cable is wound around the reel or drum. In a preferred embodiment of the invention, the marker system may further comprise a viscous medium.

In a further embodiment of the invention, the viscosity of the marker system may be adjusted to enhance adhesion of the marker system to the cable thereby limiting movement of the marker system on the cable, particularly when the cable is being manufactured and/or optionally when cable is being wound onto the reel or drum. Further, the viscosity may provide an improved resistance against any movement of the cable when the cable is being wound onto the drum. Preferably, the viscosity can be adjusted to suit specific rotational speeds as the cable is wound onto the drum or reel. Preferably, the viscosity of the marker system is between 1.5 Pa·s to 1850 Pa·s dependent upon the type of ink and printing process used.

This embodiment can also be used to overcome the hydrophobic character of the organic insulation layer and thereby provide better more predicable adhesion. Additionally, it can be used to prevent the flow of the marker system to the lowest point of the drum or reel and to prevent marker dripping from the reel in storage immediately after the marker system is applied to the insulating surface of the cable.

In an embodiment of the invention, the marker system is applied to the insulating layer of the cable along a line extending substantially the whole length of the cable. Preferably, the line along which the marker system is applied is a thin line. In a further embodiment of the invention, the marker system is applied to the insulating layer of the cable at specific pre-determined locations along the length of the cable. This may be achieved by suitable software which removes the cable from contact with the marker as in FIG. 3 the marker bath would simply be lowered away from the cable for predetermined intervals to give sections of marked and unmarked cable.

Preferably, the marker system is applied substantially to the entire diameter of the insulating layer of the cable.

In a further embodiment of the invention there is provided that the unique nature of each marker system can be checked during Quality Control following manufacture.

In a further embodiment of the invention, there is provided a marker system for applying to the surface of an insulating layer of a cable, said marker system comprising: an indicator material; a unique fingerprint capable of distinguishing one marker system from that of another and of identifying the source of the item to which it is coupled; and a viscosity modifier capable of adjusting the viscosity of the marker system between 1.5 Pa·s to 1850 Pa·s

In one aspect of the invention, the marker system has an inherent stability capable for use in an exterior environment. It is provided that any known marker system may be used for applying to the surface of an insulating layer of a cable but preferably that the selected marker system has the inherent stability such that the cable could be used in an exterior environment.

In a further embodiment of the invention, the marker system may further comprise one or more surfactants. The use of suitable surfactants in the marker solution serves to overcome the hydrophobic nature of the organic materials, i.e. the plastic type material of the insulating layer, in order to ensure the marker system adheres to the insulating layer of the cable.

Preferably, the viscosity modifier comprises one or more proprietary thickeners. Preferably, the viscosity modifier comprises a thixotropic medium. As the marker system comprises a viscosity modifier, a thinner layer of the marker system need be applied to the insulating layer of the cable.

In one embodiment of the invention, the viscosity modifier may comprise one or more polyalkylacrylates. In another embodiment of the invention, the viscosity modifier may comprise one or more depolymerised natural rubbers.

In one embodiment of the invention, the unique fingerprint may comprise a volatile aqueous medium, together with for example a DNA trace or one or more trace materials which can be varied in such a manner as to produce unique formulations. The combinations of trace materials may advantageously be varied by modelling the compositions on, for example, binary strings to produce large numbers of unique products. However, other suitable coding methodologies may also be utilised as appropriate. The term “trace materials” applies herein to materials used at a concentration which would not normally be present in the environment of use. The most commonly used trace materials are metal compounds.

Trace materials can advantageously therefore be combined in a way which gives good evidential value to law enforcement agencies, as each unique formulation may be allocated to a particular premises, location or person, and this information is stored in a central database which can be accessed by a law enforcement agency receiving the report of a laboratory analyzing the mixtures which are to be discussed.

The trace materials may be assigned constant positions in a binary string with their presence being given by a “1”, and their absence by a “0”. If, for example, one were to set a limit of thirty digits for the string, one could begin with combinations of two trace materials, and generate all combinations containing any two trace materials. One could then go to groups of three trace materials, and generate all combinations of any three trace materials. This could continue until the number of trace materials is equal to the number of digits in the string.

With a thirty digit string, the total number of unique combinations of trace materials is approximately one billion. However, it is possible to prepare an infinite number of mixtures having compositions based upon unique binary sequences, the composition of each being unique.

Binary strings are provided as exemplary of the manufacturing procedures which can be used. Octal strings may also be used. Decimal numbers and random number generation can be used to generate potential codes, although these will need to be checked and converted to binary or octal sequences prior to use.

The unique nature of each composition can be checked during Quality Control following manufacture. The composition can then be stored in a database, allocated to a premises, location, or person, and the ownership of goods located at a later time can be identified relating to the premises, location or person via the composition.

Of course, the greater the number of trace materials used, the greater the certainty in identification later on, since the chance presence of trace materials can be ruled out.

The detection of the trace elements used in any given marker may be undertaken by analysis of the marker layer. This can be undertaken by using various techniques depending upon the type of marker used. The various techniques all serve to offer a further level of security but require a further complicated step to determine the marker code. This is an improvement over overt markers of various types in which a code is applied along the whole length of cable or in specific positions. As overt code is visible it is quite easy for it to seen and removed by stripping the insulation layer from the cable, thereby making the valuable metal core untraceable. Similarly an overt marker may be applied to the underside of the insulation layer, but this is difficult to remove and inconclusive if the marker has only been applied periodically along the length of the cable. With a covert mark however there is no indication that the mark is present. Therefore, it is unlikely that any attempt would be made to remove the covert marker as third parties would not be aware of its presence. However, the proprietor of the cable could identify the covert marker, and therefore their cable, quite simply, by for example making it visible by typically turning on a UV light.

The present invention also provides a further advantage in that if a section of cable was stolen and the insulation layer burnt off, as does happen, then the marker would still be operational. Clearly an overt fingerprint made of plastic or ink applied to the insulator surface forming letters or digits would be destroyed in such a process. Similarly marks etched onto the insulation layer would also be destroyed in such a process. However due to the thermal stability of the materials used in the present invention both the fluorescent indicator would still be visible and the fingerprint would still be detectable. This is why those involved in this crime burn the insulation layer off rather than just cut it off and disposing of it, because they think it destroys all the evidence of their crime such as fingerprints and/or DNA. However the marker system of the present invention would withstand such a process. The fluorescent indicator will withstand flame temperatures and ashes scanned with a UV light would show the presence of the marker. Sampling of the ashes showing fluorescence followed by analysis would provide the fingerprint needed to identify the owner of the cable and possibly those involved with the crime.

The marker system preferably comprises an indicator material, which can quickly provide a preliminary, gross indication of the presence of a marker. The indicator material can either be “overt” or “covert.” An overt material is typically one which can be seen unaided by technology, such as a dye or pigment. With an overt indicator, it is immediately evident from an observation of the article or person that a mark has been provided thereon which may act as a deterrent. In one embodiment both a covert and overt mark may be applied thus combining the deterrent effect of the overt mark with the covert properties of the covert mark. For example, if the overt mark failed to act as a deterrent and the perpetrator tried to remove the overt mark; even if they were successful the stolen item could nevertheless still be identified by virtue of the covert mark.

A covert indicator combined with covert trace materials as the fingerprint will remain hidden until some technical means or stimulus is used to make it visible. Usually, a covert indicator will become visible upon application of a radiation source other than visible light, and of these, fluorescent indicators are most common. Thus, the covert indicator will often be at least one fluorescent material, and which is easily detectable upon examination with ultraviolet light, for example.

It is possible to utilise a fluorescent material which when exposed to UV light or IR light fluoresces in a particular colour, each particular fluorescent material being selected for a particular customer, so that when the composition containing the selected fluorescent material is applied to a surface of articles or goods, then any unauthorised removal of such articles or goods can be linked back to the particular customer as the source of goods. It is further possible to utilise a combination of two or more fluorescent materials having differing λ max emission wavelengths.

It is possible to identify said two or more materials by utilising a UV-absorption spectrum or a fluorescent emission spectrum of an indicator. Accordingly, such combination of materials, when applied to a surface of articles or goods, can also be used to link the particular goods to the customer. Alternatively or additionally, the indicator may comprise at least one phosphorescent material capable of phosphorescing when subjected to stimulus.

When the gross indicator means is fluorescent, the composition can include one or more of any suitable fluorescent materials.

In one embodiment of the invention there is provided a device capable of executing the method described herein. In a further embodiment of the invention, there is provided a uniquely identifiable cable comprising a marker system formed by the method described herein.

Various alterations and modifications may be made to the present invention without departing from the scope of the invention.

A number of embodiments have been described herein. However, it will be understood by persons skilled in the art that other variants and modifications may be made without departing from the scope of the embodiments as defined in the claims appended hereto.

1. A method for manufacturing a uniquely identifiable cable, the method comprising:
providing one or more cables including an insulating layer thereon to be wound onto a drum or reel; and
applying a marker system onto the surface of the insulating layer of the one or more cables prior to or during the winding of the one or more cables onto the drum or reel.

2. The method of claim 1, wherein the marker system is capable of withstanding flame temperatures.

3. The method of claim 1, wherein the marker system is applied to the insulating layer of the cable by spraying.

4. The method of claim 1, wherein the marker system is applied to the insulating layer of the cable by passing the cable between brushes.

5. The method of claim 1, wherein the marker system is applied to the insulating layer of the cable by passing the cable through a bath or reservoir containing the marker system.

6. The method of claim 1, wherein the marker system is applied to the insulating layer of the cable by passing the cable between rollers.

7. The method of claim 6, wherein the marker system is applied to the insulating layer between three rollers.

8. The method of claim 7, wherein two of the rollers are tensioning rollers and one of the rollers transfers the marker system from a reservoir to the cable.

9. The method of claim 8, wherein the roller which transfers the marker system from a reservoir to the cable is lowered periodically so that the marker system is applied only to sections of the insulating layer of the cable.

10. The method of claim 1, wherein the marker system is applied to the insulating layer of the cable by passing the cable between pads.

11. The method of claim 10, wherein tubing connects the pad applicators to a reservoir containing the marker system.

12. The method of claim 11, wherein the tubing is telescopic to allow for differences in the cable height relative to the applicator.

13. The method of claim 5, wherein the bath or reservoir further comprises a unique fingerprint capable of distinguishing one marker system from that of another and of identifying the source of the item to which it is applied.

14. The method of claim 13, wherein an alarm is provided to indicate when the amount of marker system in the reservoir or bath has reached a predetermined low level.

15. The method of claim 1, wherein the insulation layer comprises a plastic type material.

16. The method of claim 15, wherein the insulation layer comprises polyvinyl chloride.

17. The method of claim 16, wherein the insulation layer comprises polyethylene.

18. The method of claim 15, wherein the insulation layer comprises a combination of polyvinyl chloride and polyethylene.

19. The method of claim 1, wherein the method further comprises the step of drying the cable once the marker system has been applied onto the insulating layer.

20. The method of claim 19, wherein the step of drying the cable is by use of rapid drying means.

21. The method of claim 19, wherein the marker system is dried onto the insulating layer of the cable prior to the cable being wound onto the reel or drum.

22. The method of claim 1, wherein a viscosity of the marker system is such that it is able to resist movement of the marker system on the cable when the cable is being manufactured and/or optionally when cable is being wound onto the reel or drum.

23. The method of claim 22, wherein the viscosity of the marker system is adjusted to suit the specific rotational speed which the cable is wound onto the drum or reel.

24. The method of claim 22, wherein the viscosity of the marker system is between 1.5 Pa·s to 1850 Pa·s.

25. The method of claim 1, wherein the marker system is applied to the insulating layer of the cable along a line extending substantially the whole length of the cable.

26. The method of claim 25, wherein the line along which the marker system is applied as a thin line.

27. The method of claim 1, wherein the marker system is applied to the insulating layer of the cable at specific pre-determined locations along the length of the cable.

28. The method of claim 1, wherein the marker system is applied substantially to the entire diameter of the insulating layer of the cable.

29. The method of claim 1, wherein the unique nature of each marker system can be checked during Quality Control following manufacture.

30. A marker system for applying to the surface of an insulating layer the marker system comprising:
an indicator material;
a unique fingerprint capable of distinguishing one marker system from that of another and of identifying the source of the item to which it is applied; and
a viscosity modifier capable of adjusting the viscosity of the marker system between 1.5 Pa·s to 1850 Pa·s.

31. The marker system of claim 30, wherein the marker system has an inherent stability capable for use in an exterior environment.

32. The marker system of claim 30, wherein the marker system is capable of withstanding flame temperatures.

33. The marker system of claim 30, wherein the indicator material is capable of withstanding flame temperatures.

34. The marker system of claim 30, wherein the marker system is water based.

35. The marker system of claim 30, wherein the composition of the marker system is substantially similar to an ink dispersion.

36. The marker system of claim 35, wherein the marker system is an ink.

37. The marker system of claim 30, wherein the composition of the marker system is substantially similar to a pigment dispersion.

38. The marker system of claim 30, further comprising one or more surfactants.

39. The marker system of any of claim 30, further comprising one or more anti-foaming agents.

40. The marker system of claim 30, wherein the marker system comprises a viscosity modifier comprising one or more proprietary thickeners.

41. The marker system of claim 30, wherein the viscosity modifier comprises a thixotropic medium.

42. The marker system of claim 30, wherein the viscosity modifier comprises one or more polyalkylacrylates.

43. The marker system of claim 30, wherein the viscosity modifier comprises one or more depolymerised natural rubbers.

44. The marker system of claim 30, wherein the viscosity modifier comprises a combination of the one or more proprietary thickeners, the thixotropic medium, the one or more polyalkylacrylates and/or optionally the one or more depolymerised natural rubbers.

45. The marker system of claim 30, wherein the fingerprint comprises a solvent medium and one or more trace materials.

46. The marker system of claim 45, wherein the trace materials comprise metal compounds or unique sequences of nucleic acids.

47. The marker system of claim 45, wherein the trace materials are assigned constant positions in a binary string.

48. The marker system of claim 45, wherein the trace materials are assigned to constant positions in an octal string.

49. The marker system of claim 30, wherein the indicator material is overt and can be seen unaided by technology.

50. The marker system of claim 30, wherein the indicator material is a dye and/or optionally a pigment.

51. The marker system of claim 30, wherein the indicator material is covert and will remain hidden until subjected to a predefined stimulus.

52. The marker system of claim 30, wherein indicator material is both a covert and overt mark.

53. (canceled)

54. (canceled)
